(19) United States
(12) Patent Application Publication
(10) Pub. No.: US 2002/0176962 A1
(43) Pub. Date: Nov. 28, 2002

(54) Protector structure

(76) Inventor: Ju-Sung Chang, Nantou (JP)

Correspondence Address: RABIN & CHAMPAGNE, P.C., Suite 500, 1101 14th Street, N.W., Washington, DC, 20005, US

(21) Appl. No.: 09/864,175

(22) Filed: May 25, 2001

(51) Int. Cl. B32B 3/10

(52) U.S. Cl. 428/143; 428/138

(57) ABSTRACT

The present invention relates to an improved protector structure, made by selecting the material for the surface layer, elastic buffer layer, and foam layer. After being pressed in the mold and pasted together, the sticky ribbon and buckle are being sewed to protector for reinforcement. By means of the ventilation chamber and the ventilation passage of the foaming layer and the protruded buffer member of the elastic buffer layer, it enhances the comfort, ventilation, and slippery-proof of the entire sample of the invention. The design of a multiple layered buffer is used to release and disperse the impact of external forces, which is applicable for the need by humans and animals. It makes the quality of the product more reliable, and its structural design is novel, useful, and enhanced having the effect that meets our expectation.

### BACKGROUND OF THE INVENTION

1. Field of the Invention

The present invention relates to an improved protector structure, more particularly to a structure made by selecting the material for the surface layer, elastic buffer layer, and foam layer.

2. Description of the Prior Art

In general, the conventional protector comprises a hard casing, a flat foaming layer, three sticky buckled ribbons, and three buckles; and the sticky buckled ribbon and the buckles are fixed by sewing their both lateral sides. However, the prior art product generally has its shortcomings in buffer, slippery proof and ventilation effects; and does not meet the competition in the market and the needs of consumers based on the consideration of cost.

In view of the shortcomings and inconvenience of the prior art mentioned above, which are the subjects of improvements for a long time, hence the inventor of the present invention based on years of experience accumulated from the engagement in the related industry conducted extensive research to resolve the foregoing shortcomings and invented the present invention.

Therefore, the primary objective of the present invention is to provide an improved protector structure, and by means of selecting the material for the elastic buffer layer to provide a better buffer effect and enhance the attachment effect; in addition to the design of forming a ventilation passage and a ventilation chamber in the foam layer by the foam technology, and the design of the anti-slippery particles that improve the ventilation, exhaust, and slippery proof effects in order to protect the user for safety purpose, provide comfort, convenience to meet the users requirement, minimize the cost of the product, improve the competitiveness of the similar products in the market, and meet the requirement of the quality standard of the product. Furthermore, the application of the product can be used to protect the joints of animals as well as the joints of human beings.

To make it easier for our examiner to understand the objective of the invention, structure, innovative features, and performance, we use a preferred embodiment together with the attached drawings for the detailed description of the invention.

### BRIEF DESCRIPTION OF THE DRAWINGS

Other objects, features, and advantages of the invention will become apparent from the following detailed description of the preferred but non-limiting embodiment. The description is made with reference to the accompanying drawings, in which:

FIG. 1 shows the three-dimensional external look of a prior product.

FIG. 2 shows the disassembled parts of a first preferred embodiment of the present invention.

FIG. 3 shows the three-dimensional external look of the first preferred embodiment of the present invention.

FIG. 4 shows the side view of the structure of the first preferred embodiment of the present invention.

FIG. 5 shows the structure of the bottom of the elastic layer of the foam layer of the first preferred embodiment of the present invention.

FIG. 6 shows the first preferred embodiment of the present invention.

FIG. 7 shows the side view of the structure of a second preferred embodiment of the present invention.

FIG. 8 shows the three-dimensional diagram of the buffer body produced by the structural elastic foam layer of the second preferred embodiment of the present invention.

FIG. 9 shows the protection of the fixing position effect when the structural elastic foam layer is attached to the human body according to the second preferred embodiment of the present invention.

FIG. 10 is an enlargement of the diagram of the anti-slippery particles on the elastic foam layer and the ventilation passage.

### DESCRIPTION OF THE PREFERRED EMBODIMENT

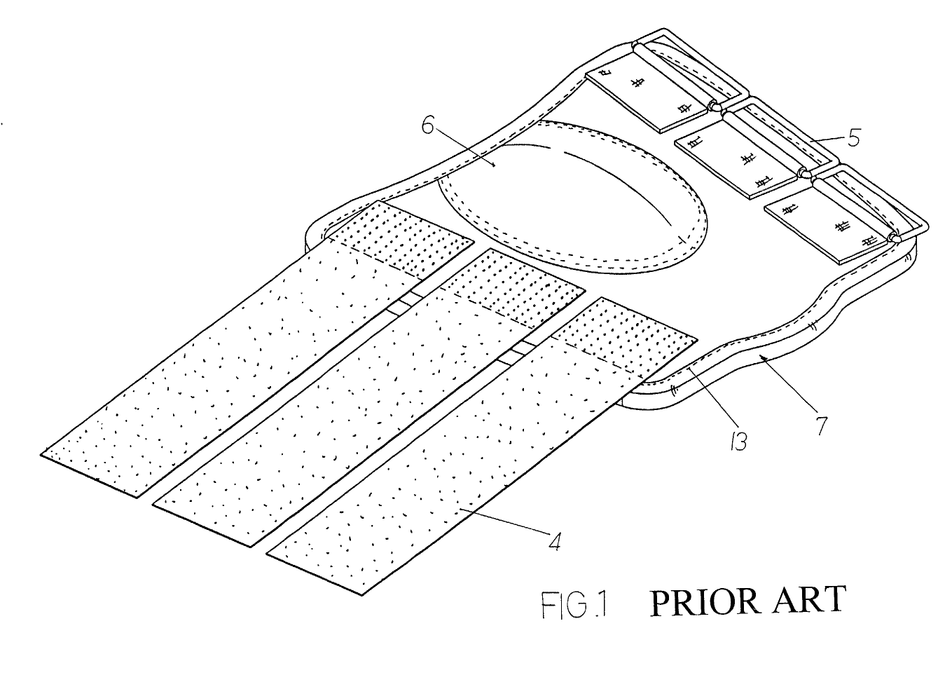

Please refer to FIG. 1 which shows the structure of a prior art protector, comprising a hard casing 6, three buckles 5, three buckled sticky ribbon (4), a flat foam layer (7), and these components are coupled by sewing a sewing line (13).

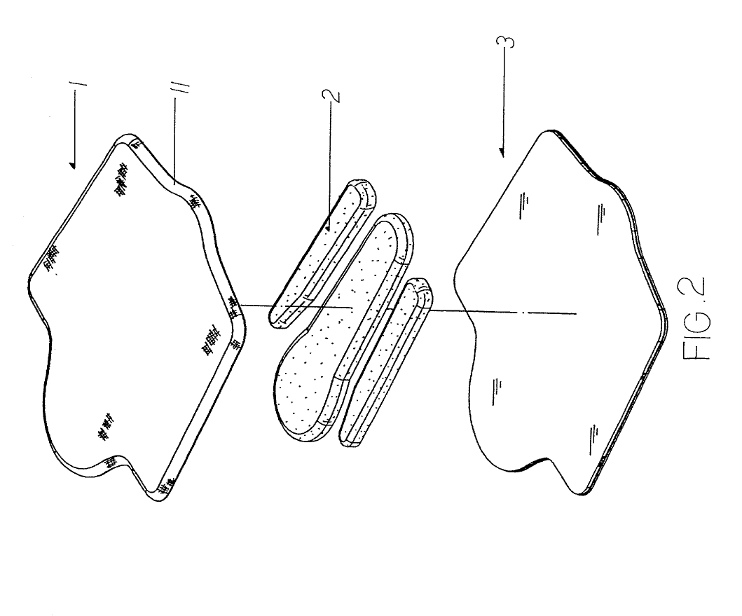

Please refer to FIG. 2 which shows an improved protector structure of the present invention, comprising a surface cloth (11) that is attached onto a soft lining pad and forms the outer layer (1), and the third layer is a bottom layer comprising a plurality of anti-slippery particles (31), and a foam layer (3) having a plurality of ventilation passages (32) which is an integral structural design. The second layer is an elastic buffer layer (2) made of the chemical substance GEL (which can be substituted by other equivalent chemical materials), which has the property of elasticity and memory resuming capability. When external forces are exerted onto it, the impact will be spread out and then it will resume into the original appearance.

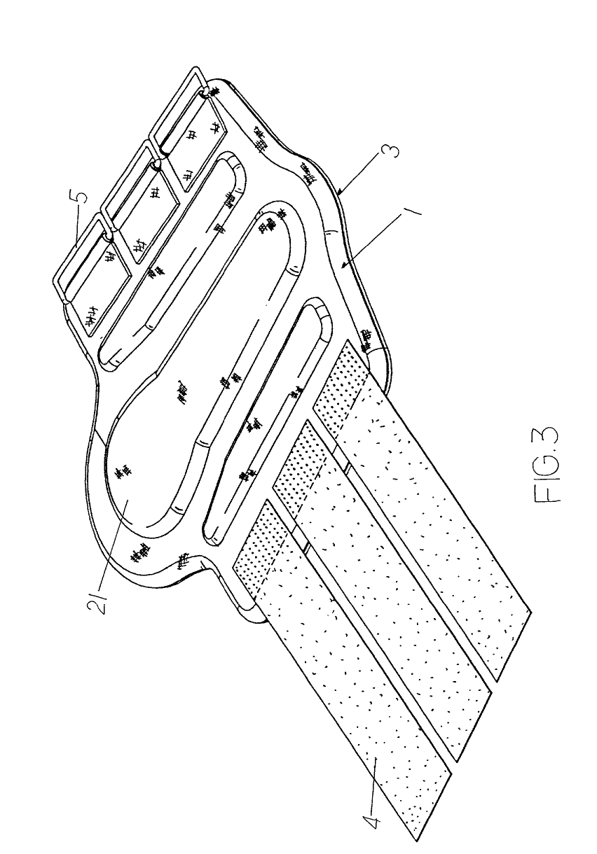

Furthermore, please refer to FIG. 3. An improved structure of a protector has a foam layer (3) as its top surface being coated with a layer of chemical material GEL to produce a bulky look, and it has a buffer elastic layer (2) with sticky and elastic properties. In addition to providing the stickness for the attachment between the surface layer (1) and the foam layer (3), it also forms a buffer body to disperse the impact of the external forces. The surface layer (1) comprises a surface cloth (11) being attached onto the soft lining pad (12). Since the surface cloth (11) is weaved with wool material having a grid pattern (other materials or patterns can be used for the substitute) being transplanted by attaching it onto the soft lining pad, and then the bulky elastic buffer layer being attached onto of it, and a three-buckled ring (5) and three sticky belt (4) are disposed separately on the appropriate position on both sides of the front end of the surface layer (1), and the protector being sewed with sewing lines to improve the quality of the protector structure.

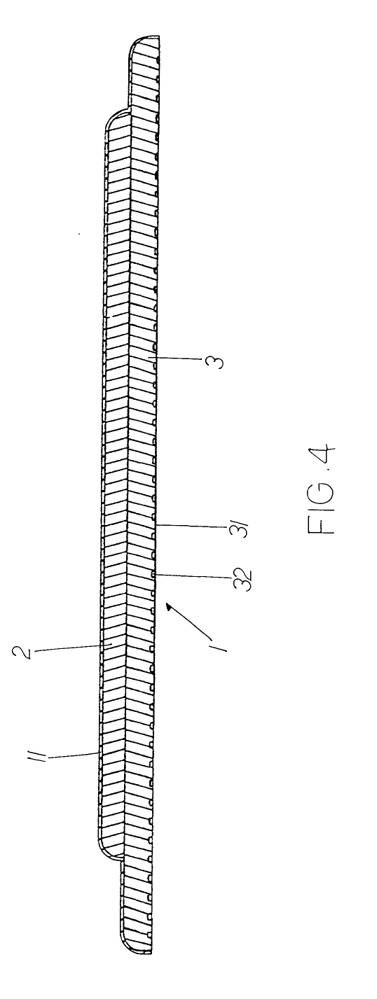

Furthermore, please refer to FIG. 4 for an improved protector structure. The figure shows a side view of the cross section of the sample wherein the bottom of the foamed layer (3) having a ventilation passage (3) and a plurality of anti-slippery particles for better ventilation, discharge, and anti-slippery effect.

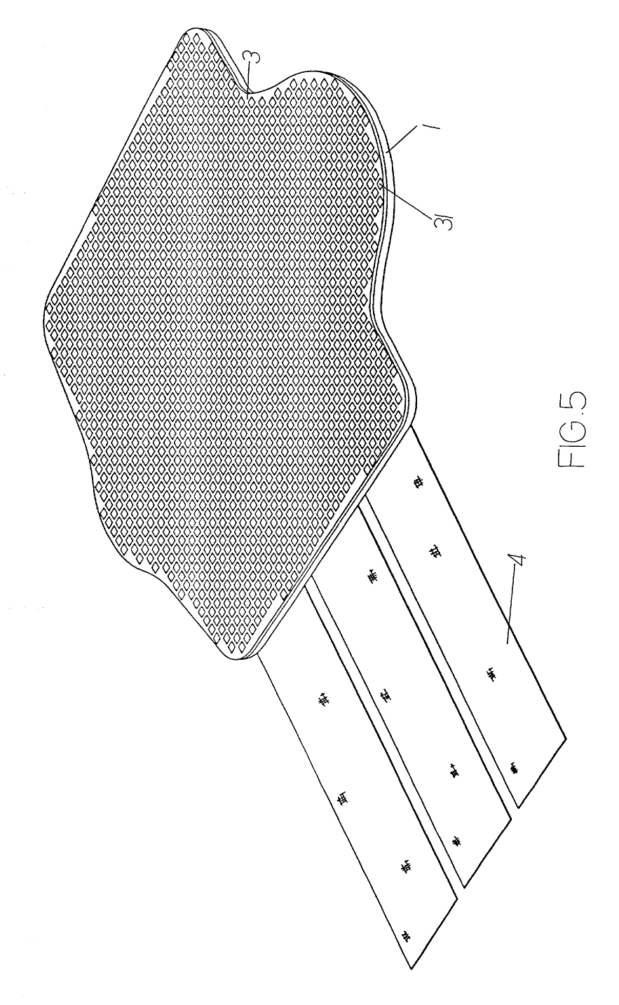

Further, please refer to FIG. 5 which shows an improved protector structure wherein the anti-slippery particles (31) and the ventilation passage (32) at the bottom of the foamed layer (3) are formed in the shape of a square framed net (of course, it also can be arranged in other shapes).

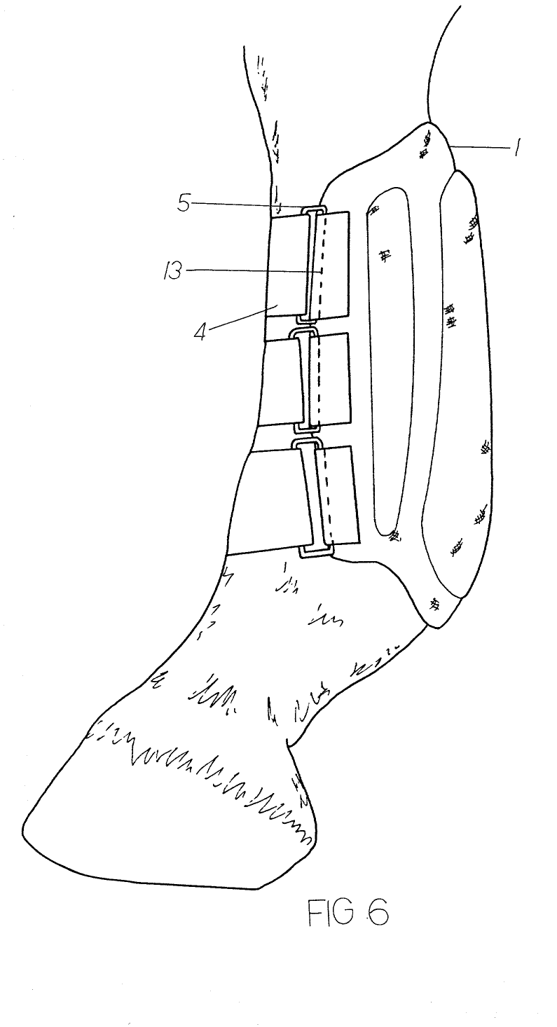

Please refer to FIG. 6, which shows an application of the improved protector being used on the joints of an animal for its protection structure.

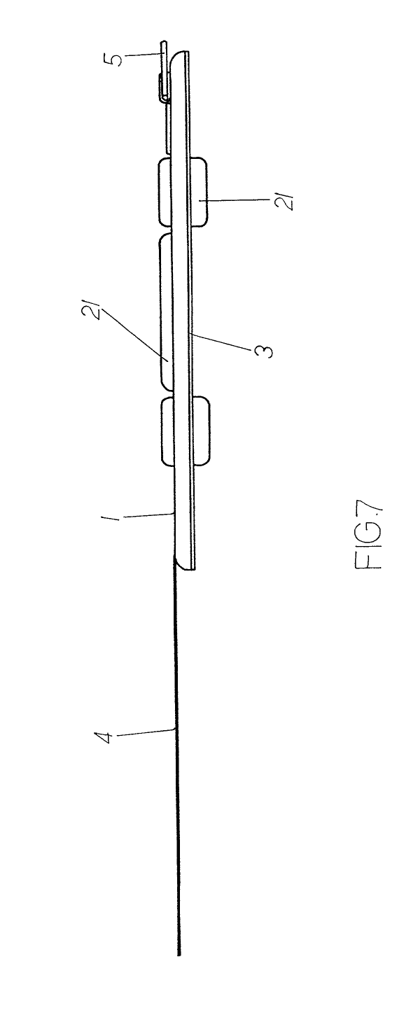

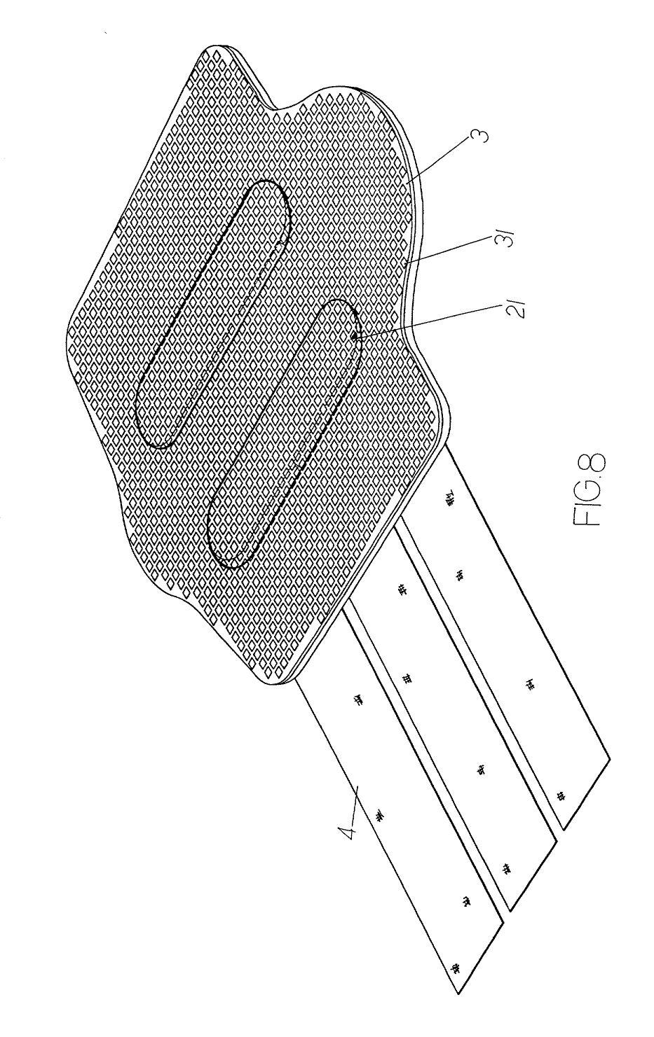

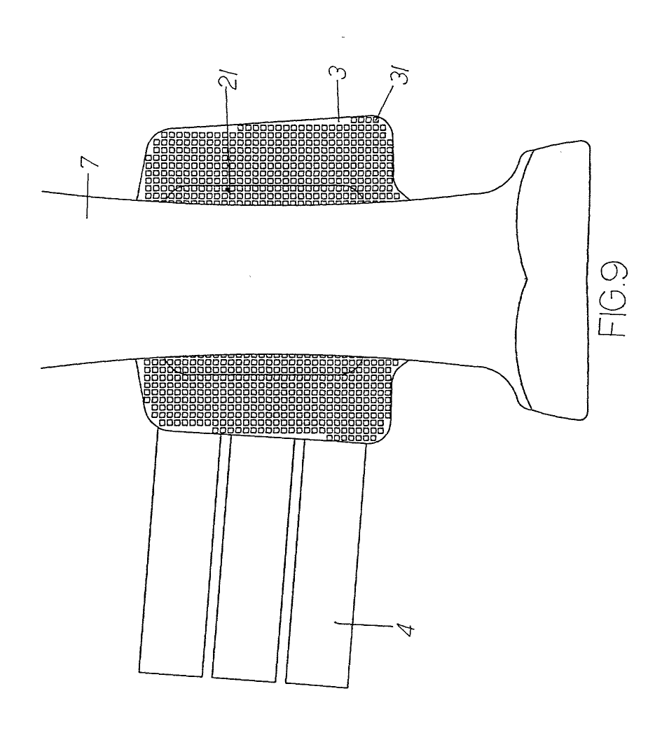

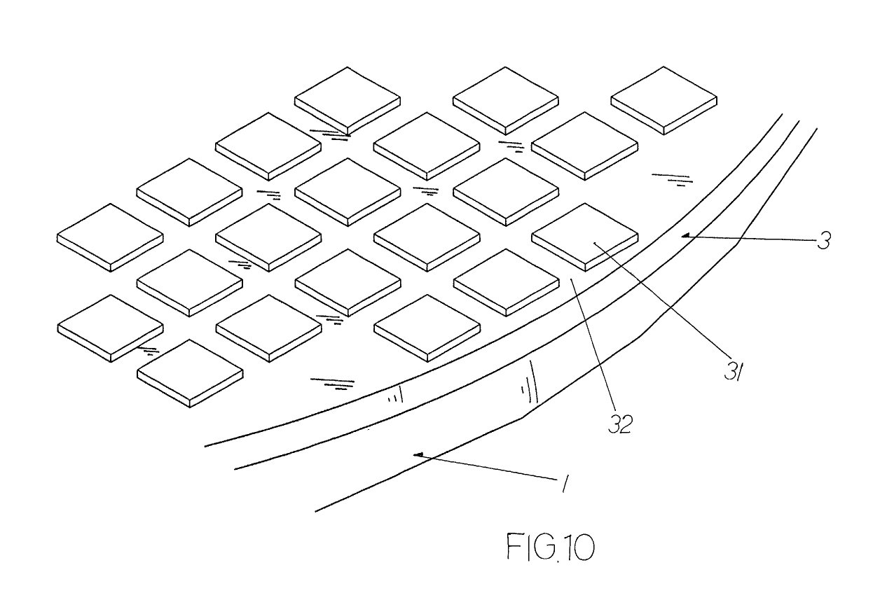

Finally refer to FIGS. 7, 8, 9, and 10. Another embodiment of the present invention may have the structure similar to the one described above, except the elastic foamed layer (3) may be made of the structure of a buffer body (21), such that both sides of the protector have the buffer body (21), and the design still has anti-slippery particles and ventilation passage on the buffer body. Please refer to FIGS. 8 and 9. The buffer body of the elastic foamed layer (3) can be used to fixed onto the human body or animal limbs or joints such that the protector will not swing sideway, and further has the anti-collision, fixing, ventilation, and anti-slippery effect.

Therefore, in summation of the above description, the present invention provides a better product by selecting appropriate materials for the components, improving the manufacture skills in order to simplify the types of components and quantity, making the assembly more easily and more artistic in appearance, accomplishing better safety in its application, improving the slippery proof effect and the ventilation effect and enhance the total performance of the actual use of the protector. This improved structure is the research and development subject for enhancement. The inventor of the present invention based on years of experience in the related industry conducted extensive research to enhance the structure of the protector herein which is hereby submitted for patent application.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. An improved protector structure, having a surface layer at the top of the protector, a foam layer at the bottom of the protector, and an elastic buffer layer between the surface layer and the foam layer; the surface layer and the foam layer are coupled by means of the pressed molding by machines and molding tools such that the surface layer and the foam layer have a buffer layer on which a protruded buffer member is formed and a plurality of anti-slippery particles and a plurality of ventilation passages are disposed on the foam layer.

2. An improved protector structure as claimed in claim 1, wherein said surface layer comprising a surface cloth and a soft lining pad of which are coupled by means of heating, pressurization, and vacuum by machines and molds.

3. An improved protector structure as claimed in claim 1, wherein said elastic buffer layer is a GEL layer made of a chemical GEL (also known as latex and emulsion) and PU according to a proportion, which has a property of having a memory to restore the original shape after many times of use, and capable of forming a buffer to release the impact of external forces.

4. An improved protector structure as claimed in claim 1, wherein said foam layer is an elastic body made of plastic foam having a plurality of anti-slippery particles transversally and longitudinally interlaced and equidistantly distributed at its bottom, and a ventilation passage being disposed between every two anti-slippery particles which further provides another buffering area to attain the effects for the user's comfort, easy perspiration, and slippery proof purpose.

5. An improved protector structure as claimed in claim 1, wherein said elastic foam layer could be made as a structure of the buffer body such that both side of the protector have buffer body, and said buffer body still has the design of anti-slippery particles and ventilation passages.
